(19) United States
(12) Patent Application Publication
(10) Pub. No.: US 2009/0112843 A1
(43) Pub. Date: Apr. 30, 2009

(54) SYSTEM AND METHOD FOR PROVIDING DIFFERENTIATED SERVICE LEVELS FOR SEARCH INDEX

(75) Inventors: Windsor Hsu, San Jose, CA (US); Shauchi Ong, San Jose, CA (US)

Correspondence Address: CANADY & LORTZ LLP- IBM, 2540 HUNTINGTON DRIVE, SUITE 205, SAN MARINO, CA, 91108, US

(73) Assignee: International Business Machines Corporation, San Jose, CA (US)

(21) Appl. No.: 11/927,167

(22) Filed: Oct. 29, 2007

(51) Int. Cl. G06F 7/10

(52) U.S. Cl. 707/5; 707/E17.014

(57) ABSTRACT

Programs, systems and methods for providing differentiated service levels for a search index are disclosed. Data object documents are processed by extracting terms and scoring each of the terms associated with each document according to criteria to indicate relative importance of the associated document. A plurality of posting lists are generated for each term each comprising entries identifying documents that include the term. The entries are allocated to the different posting lists for the given term depending upon the score for the term associated with particular document. The different posting lists, e.g. a high score and low score posting list, may then be stored as data objects managed according to their indicated importance. For example, the high score posting list data object may be stored in higher performance storage than the low score posting list data object. Scores may be regularly updated.

### BACKGROUND OF THE INVENTION

1. Field of the Invention

This invention relates to search indexing. Particularly, this invention relates to creating differentiated service levels to make searching more efficient.

2. Description of the Related Art

Organizations are collecting and accumulating more data than ever before. Managing such huge amounts of data can be both expensive and complex. In practice, the stored data may have different activity profiles and value to the organization. If each data object, such as a file, were to be managed in accordance with its activity profile and value to the organization, the cost and complexity of managing the data may be significantly reduced. The general approach of providing differentiated service levels for data objects is generally known as information lifecycle management (ILM).

Data objects, however, represent only a portion of the data that must to be retained and managed. As the collection of data objects grow, being able to search the collection to retrieve relevant information becomes critical. Accordingly, the search index (e.g., an inverted index) that is required to provide this capability tends to become large. In some cases, the search index may even occupy more storage space than the data objects themselves.

Traditional Hierarchical Storage Management (HSM) approaches use the access history to predict the value of objects. However, this technique is not effective for handling a search index because of the manner in which the search index is stored in data objects—valuable and less valuable index data tends to be mingled in the same data object. Similarly, inferring the value of an object based on metadata characteristics such as the type of object, who created the object, when it was created, etc., has limited effectiveness for data objects containing search index data. The search index may be divided up based on the age of the data objects indexed, and portions of the search index that correspond to older objects could be archived to tape. However, such an approach offers only coarse-grained management of the search index data.

FIG. 1A illustrates a conventional search index 100. The features 102A & 102B are the search features or terms that are searched for when a search is initiated. For each feature 102A & 102B, there are accompanying posting lists 104A & 104B containing entries 106A-106H. The posting lists identify all the documents as entries which include the specified feature. For example, posting list 104B for feature ‘IBM’ 102B includes an entry 106D that identifies a document “ . . . X bought an IBM PC . . . ” as containing the feature ‘IBM’ 102B and an entry 106F that identifies IBM's Financial Report as containing the feature ‘IBM’ 102B. The entries in the posting lists are typically ordered by time of the entries creation. Different techniques for enhancing the handling of search indexes have been developed.

U.S. Patent Application Publication No. 2006/0072136 by Hodder et al., published Apr. 6, 2006, discloses a multiple font management system and method in a printing device for activating multiple fonts is provided for enabling base font localization and font patching for print jobs to reduce the need to upload entire fonts in order to provide localized receipts or to provide corrections to partially-corrupted font tables. A font access level stores locations of activated base, localization and patch fonts and are referenced in an access order during character retrieval so as to apply retrieval priority to patches and localizations. A font storage level maintains multiple tier character indices for referencing character shape data in order to provide faster character searching through each of the multiple activated fonts than a single-level index.

U.S. Patent Application Publication No. 2005/0197885 by Tam et al., published Sep. 8, 2005, discloses a system and method for allowing users to participate in a campaign, preferably using SMS messaging. The system includes a first layer configured to receive information from a user via a user interface, a second layer configured to extract data relevant to the campaign from the information received by the first layer, and a third layer configured to compare the extracted data to requirements of the campaign and, if the extracted data complies with the requirements of the campaign, to store the extracted data in a database associated with the campaign.

U.S. Pat. No. 6,973,616 by Cottrille et al., issued Dec. 6, 2005, discloses a computing system capable of associating annotations with millions of content sources is described. An annotation is any content associated with a document space. The document space is any document identified by a document identifier. The document space provides the context for the annotation. An annotation is represented as an object having a plurality of properties. The annotation is associated with a content source using a document identifier property. The document identifier property identifies the content source with which the annotation is associated. A scalable computing system for managing annotations responds to requests for presenting annotations to millions of documents a day. The computing system consists of multiple tiers of servers. A tier I server indicates whether there are annotations associated with a content source. A tier II server provides an index to the body of the annotations. A tier III server provides the body of the annotation.

U.S. Pat. No. 6,516,320 by Odom et al., issued Feb. 4, 2003, discloses a memory for access by a program being executed by a programmable control device includes a data access structure stored in the memory, the data access structure including a first and a second index structure (each having a plurality of entries) together forming a tiered index. At least one entry in the first structure indicates an entry in the second structure. The number of entries in the second structure being dynamically changeable. A method for building a tiered index structure includes building a first-level index structure having a predetermined number of entries, building a second-level index structure having a dynamic number of entries, and establishing a link between an entry in the first-level index structure and an entry in the second level index structure.

U.S. Pat. No. 5,301,314 by Gifford et al., issued Apr. 5, 1994, discloses a computer-aided customer support system is described for rapidly retrieving stored documents useful in answering customer inquiries. A hierarchical index tree is used in which an indexing document is referenced at each level as the search proceeds down through the various tiers. Once the targeted document is retrieved and reviewed, the user is interrogated by the system as to the usefulness of the document in solving the customer's inquiry. Based on the response to this interrogation, the usefulness priority and location of this document within the tree structure are reevaluated.

In view of the foregoing, there is a need to provide differentiated service levels for a search index. There is a need in the art for systems and methods to effectively determine the importance of a portion of the search index. Further, there is a need for such systems and methods to manage the portion of the search index according to its determined importance. These and other needs are met by the present invention as detailed hereafter.

### SUMMARY OF THE INVENTION

Programs, systems and methods for providing differentiated service levels for a search index are disclosed. Data object documents are processed by extracting terms and scoring each of the terms associated with each document according to criteria to indicate relative importance of the associated document. A plurality of posting lists are generated for each term each comprising entries identifying documents that include the term. The entries are allocated to the different posting lists for the given term depending upon the score for the term associated with particular document. The different posting lists, e.g. a high score and low score posting list, may then be stored as data objects managed according to their indicated importance. For example, the high score posting list data object may be stored in higher performance storage than the low score posting list data object. Scoring may be based on term frequency in a document and inverse document frequency as well as an applied weighting factor to further adjust the results.

A typical computer program embodiment of the invention comprises program instructions for determining a score for a posting list entry associated with a term, the posting list entry identifying a document including the term, program instructions for selecting a posting list corresponding to the term among one of at least a high score posting list and a low score posting list based on the score, and program instructions for saving the posting list entry in the posting list selected based on the score. Some embodiments of the invention may include program instructions for updating the score and repeating selecting the posting list and saving the posting list entry in the selected posting list. In addition, updating the score and repeating selecting the posting list and saving the posting list entry may be performed in response to at least one of a user issuing a command, a change in a weighting list for the term, and a storage need for the high score posting list. The high score posting list may be saved in a higher performance storage and the low score posting list may be saved in a lower performance storage.

In some embodiments of the invention, the score may be proportional to both a term frequency within the document and an inverse document frequency among a document collection. The score may be determined by multiplying the term frequency and the inverse document frequency by a weighting factor associated with the term. Further, the weighting factor may be assigned to adjust the score for at least one variable of a proximity of associated terms, a recent access, and a time-based adjustment.

Additional embodiments of the invention may also include program instructions for receiving a search term, program instructions for accessing the high score posting list associated with the search term to determine a document including the search term, and program instructions for returning the determined document as a search result. In addition, the computer program may further include program instructions for receiving a request for an additional search result, program instructions for accessing the low score posting list associated with the search term to determine a document including the search term, and program instructions for returning the determined document as a search result.

In a similar manner, a typical method embodiment of the invention, comprises determining a score for a posting list entry associated with a term, the posting list entry identifying a document including the term, selecting a posting list corresponding to the term among one of at least a high score posting list and a low score posting list based on the score, and saving the posting list entry in the posting list selected based on the score. Method embodiments of the invention may be further modified consistent with the system or program embodiments described herein.

In addition, a typical system embodiment of the invention may comprise a processor for determining a score for a posting list entry associated with a term, the posting list entry identifying a document including the term and for selecting a posting list corresponding to the term among one of at least a high score posting list and a low score posting list based on the score, and a storage for saving the posting list entry in the posting list selected based on the score. The storage may comprise a higher performance storage and a lower performance storage such that the high score posting list is saved in the higher performance storage and the low score posting list is saved in the lower performance storage. System embodiments of the invention may be likewise modified consistent with the method or program embodiments described herein.

### BRIEF DESCRIPTION OF THE DRAWINGS

Referring now to the drawings in which like reference numbers represent corresponding parts throughout:

FIG. 1A illustrates a conventional search index;

FIG. 1B illustrates an exemplary embodiment of the invention;

FIG. 2A illustrates an exemplary computer system that can be used to implement embodiments of the present invention;

FIG. 2B illustrates an exemplary network of computing devices that can be used with embodiments of the present invention;

FIG. 2C illustrates en exemplary index engine with embodiments of the present invention

FIG. 3 shows a flowchart of the general process of an exemplary embodiment of processing a document;

FIG. 4 shows a flowchart displaying a more detailed description of the steps involved in processing a document;

FIG. 5 shows a flowchart of an exemplary embodiment of a search index with differentiated service levels; and

FIG. 6 shows a flowchart of a general process of an exemplary embodiment of maintaining differentiated service levels during a search process.

### DETAILED DESCRIPTION OF THE PREFERRED EMBODIMENT

1. Overview

Embodiments of the invention are directed to effectively determining the importance of a portion of the search index and to managing that portion of the search index according to its determined importance. The importance of a portion of the search index can be assessed according to the likelihood that it will be used in the near future, actual use, and/or the value that it's use can bring to an organization. An exemplary embodiment of the invention can operate by associating a score (indicating importance) with a portion of the index, and managing the portion of the index based on the associated score.

Managing the portion of the search index includes determining where the search index portion should be stored among different types of storage or different locations within a performance-differentiated storage, e.g., whether the portion should be stored in a first tier storage (e.g., a high-end disk array or PDA storage) or a lower tier storage (e.g., low-end disk array, tape or server storage). For example, the first tier storage might be reserved for the highest scored portions of the index that fit within 1 TB of storage or the top ten thousand portions of the index. Managing the portion of the search index also includes determining the number of copies of the portion to maintain and whether the portion of the search index should be remotely replicated. Managing the portion of the search index further includes determining the order in which or the priority with which the portion should be retrieved from a remote or backup system.

In one embodiment of the invention, search queries may be handled by first using portions of the search index that are scored highly. The portions of the search index that have been assigned lower scores are used only as a second resort, for example, when a user posing the queries request search results beyond what is provided from the highly scored portions of the search index.

A typical search index comprises a dictionary of features and a set of posting lists. Each posting list tracks the data objects that contain a particular feature. For example, the posting list comprises entries, each of which identifies an object that contains the particular feature. For example, in a full-text index, the features are the words or terms that occur in the documents to be indexed. For each term, there is a posting list that records the documents containing that particular term. For ease of explanation, we will use full-text index in this description but it should be apparent that the same ideas can be applied to other search indices.

An exemplary embodiment of the invention includes receiving a document to be indexed, parsing the document to extract the terms in the received document, creating posting list entries for the terms in the received document, assigning a score to each of the posting list entries, and saving the assigned score and managing each posting list entry based on the assigned score.

The posting list entries corresponding to a given term in a document may be grouped into data objects based on their scores, and each resulting data object is managed based on the scores of its entries. For example, the posting list entries for a term may be grouped into two data objects, one for entries that score a specified threshold or higher and one for entries that score below the specified threshold. The data object containing entries that score below the threshold is stored in second tier storage.

Each entry in the dictionary may be assigned a score and is managed based on its assigned score. For example, the dictionary entries that are scored at or above a specified threshold may be stored in a high importance data object in a first tier storage while the remaining dictionary entries may be stored in a lower importance data object in a second tier storage.

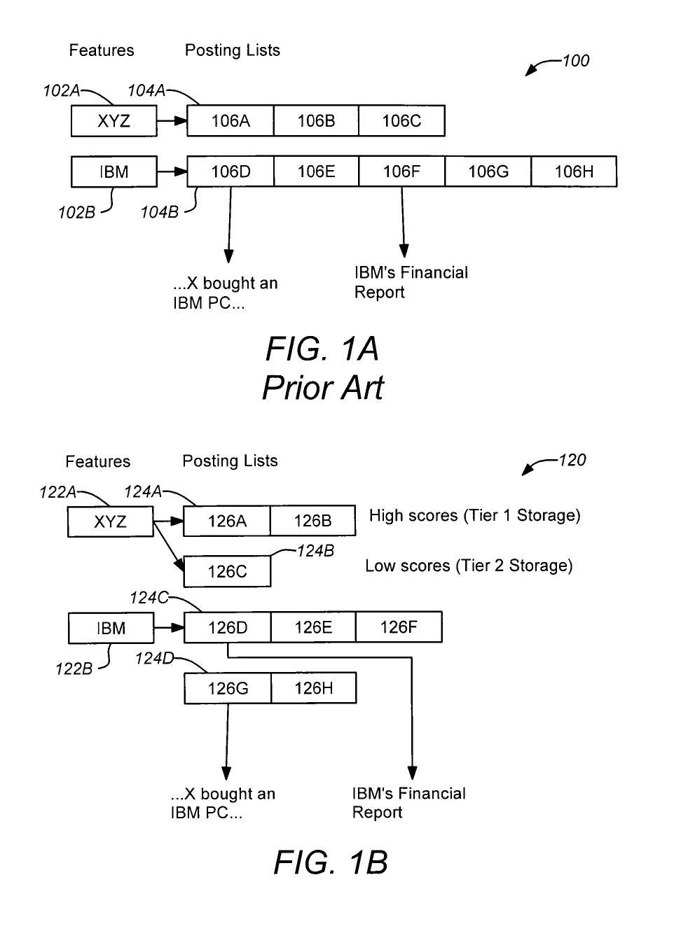

FIG. 1B illustrates an exemplary embodiment of the invention. The search index 120 includes a list of features including features 122A & 122B as well as posting lists 124A-124D comprising entries 126A-126H that identify documents that contain the respective features 122A & 122B. In the search index 120 of the exemplary embodiment of the invention, each feature 122A & 122B has a corresponding plurality of posting lists, each posting list having a different level of importance for a given feature. The different levels of importance are indicated by a value of a score.

The features 122A & 122B each have a separate corresponding high score posting list 124A & 124C and low score posting list 124B & 124D. Each entry 126A-126H for each feature 122A & 122B is scored and sorted to either the high or low score posting list for that feature. For example, for the feature ‘IBM’ 122B, the entry 126D that identifies a data object “IBM's Financial Report” has a higher importance score than the entry 126G that identifies a data object ‘ . . . X bought an IBM PC . . . ’. Thus, the entry 126D for the IBM Financial Report data object is included in the high score posting list 124C while the entry 126G for the data object ‘ . . . X bought an IBM PC . . . ’ is included in the low score posting list 124D.

Many different scoring algorithms may be applied to the entries 126D-126H depending upon the applied definition for importance. For example, in the context of a business application, an algorithm that scores based on importance to the business should be developed. This algorithm may be specific to a company or a generalized algorithm that scores business importance. Other algorithms may be developed for other applications as well as will be understood by those skilled in the art. In addition, it should also be noted that embodiments of the invention are not limited to only a high and a low score posting list; any number of importance levels may be defined, differentiated by score.

In order to improve speed and efficiency of the search process, the separate portions of the overall posting list for each feature (i.e., the high score posting list and the low score posting list) may be stored as separate data objects. Further to this end, the high score posting list data object and the low score posting list data object may then be subject to different handling by the storage management system. For example, the high score posting list data object may be stored in a faster storage device by the storage management system so that it is more quickly retrieved when a search for the applicable feature is requested. On the other hand, the low score posting list data object may be stored in a slower storage device because it is less likely to be requested by a user. In this manner, the overall search index comprising all the posting lists is divided and stored appropriate to the relative importance of the entries.

2. Hardware Environment

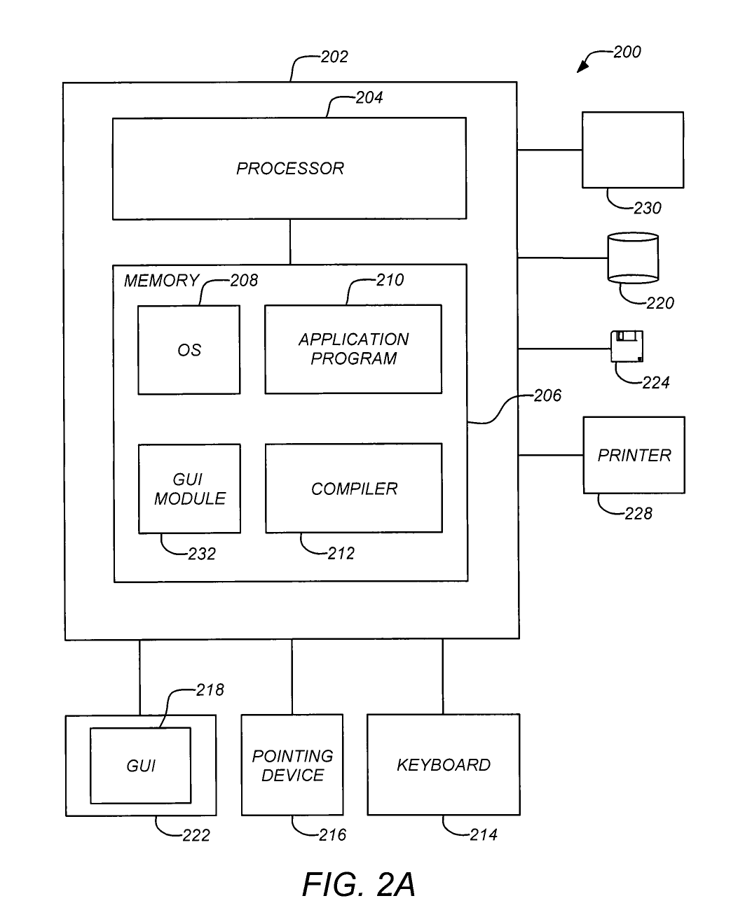

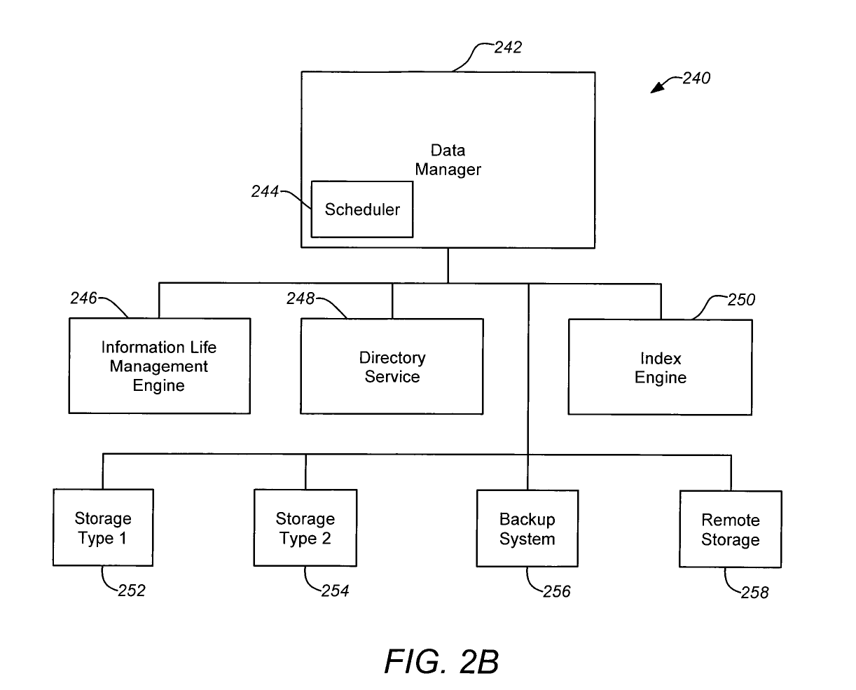

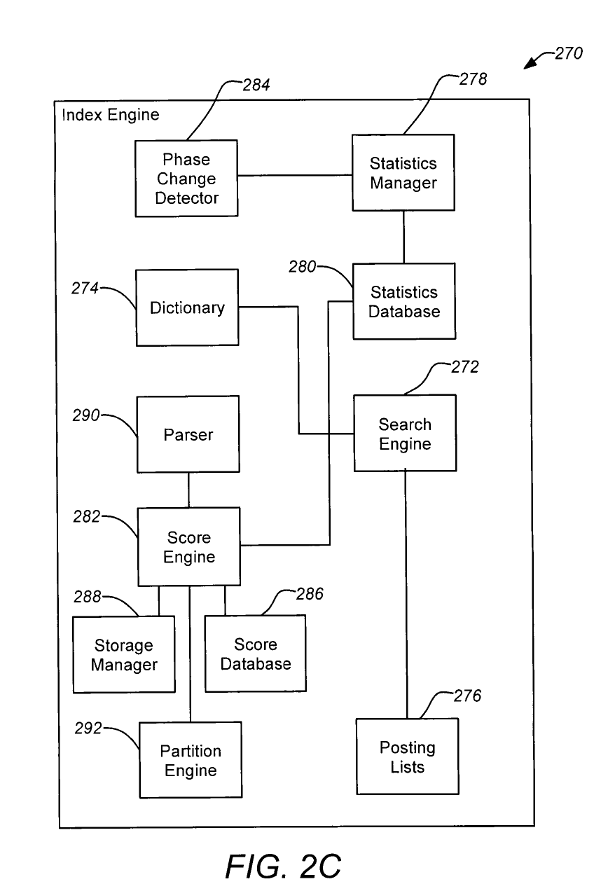

FIG. 2A illustrates an exemplary computer system 200 that can be used to implement embodiments of the present invention. The computer 202 comprises a processor 204 and a memory 206, such as random access memory (RAM). The computer 202 is operatively coupled to a display 222, which presents images such as windows to the user on a graphical user interface 218. The computer 202 may be coupled to other devices, such as a keyboard 214, a mouse device 216, a printer, etc. Of course, those skilled in the art will recognize that any combination of the above components, or any number of different components, peripherals, and other devices, may be used with the computer 202.

Generally, the computer 202 operates under control of an operating system 208 (e.g. z/OS, OS/2, LINUX, UNIX, WINDOWS, MAC OS) stored in the memory 206, and interfaces with the user to accept inputs and commands and to present results, for example through a graphical user interface (GUI) module 232. Although the GUI module 232 is depicted as a separate module, the instructions performing the GUI functions can be resident or distributed in the operating system 208, the computer program 210, or implemented with special purpose memory and processors. The computer 202 also implements a compiler 212 which allows an application program 210 written in a programming language such as COBOL, PL/1, C, C++, JAVA, ADA, BASIC, VISUAL BASIC or any other programming language to be translated into code that is readable by the processor 204. After completion, the computer program 210 accesses and manipulates data stored in the memory 206 of the computer 202 using the relationships and logic that was generated using the compiler 212. The computer 202 also optionally comprises an external data communication device 230 such as a modem, satellite link, Ethernet card, wireless link or other device for communicating with other computers, e.g. via the Internet or other network.

In one embodiment, instructions implementing the operating system 208, the computer program 210, and the compiler 212 are tangibly embodied in a computer-readable medium, e.g., data storage device 220, which may include one or more fixed or removable data storage devices, such as a zip drive, floppy disc 224, hard drive, DVD/CD-ROM, digital tape, etc., which are generically represented as the floppy disc 224. Further, the operating system 208 and the computer program 210 comprise instructions which, when read and executed by the computer 202, cause the computer 202 to perform the steps necessary to implement and/or use the present invention. Computer program 210 and/or operating system 208 instructions may also be tangibly embodied in the memory 206 and/or transmitted through or accessed by the data communication device 230. As such, the terms “article of manufacture,” “program storage device” and “computer program product” as may be used herein are intended to encompass a computer program accessible and/or operable from any computer readable device or media.

Embodiments of the present invention are generally directed to any software application program 210 that includes functions for managing a search index, e.g., in a distributed computer system comprising a network of computing devices. The network may encompass one or more computers connected via a local area network and/or Internet connection (which may be public or secure, e.g. through a VPN connection), or via a Fibre Channel Storage Area Network or other known network types as will be understood by those skilled in the art.

FIG. 2B illustrates an exemplary computer system 240 that can manage the computer operations involved with providing differentiated service levels for search indexes. The data manager 242 controls the storage, retrieval and management of data objects in the system, including data objects to be indexed and data objects containing posting lists as previously described. The scheduler 244 within the data manager 242 manages the scheduling of tasks such as movement of data objects, indexing of data objects, rescoring, etc. The Information Life Management Engine 246 provides the differentiated service levels for the data objects as previously described. The directory service 248 maintains information regarding where the data objects are located. The index engine 250 performs the actual indexing and searching of data objects. The various storage devices comprise the different types of storage or different locations within a performance-differentiated storage where the data objects are stored. Storage type 1 252 is where the higher scoring posting list data objects are stored and storage type 2 254 is where the lower scoring posting list data objects are stored. Accordingly, storage type 1 252 is a faster and/or more reliable storage than storage type 2 254. The backup system 256 can store backup information and remote storage 258 can provide an additional storage location for information.

FIG. 2C illustrates the index engine 270, which may operate within the computer system 240 from FIG. 2B. The search engine 272 uses the dictionary 274 and posting list entries 276 to answer search queries, taking into account the service level of the entries. For example, the search engine first answers the queries for one or more terms based on the entries of the corresponding posting list data objects that are stored in a first tier storage. If the user requests more results for the terms, the search engine 272 then uses the entries of the corresponding posting list data objects that are stored in a second tier storage. The statistics manager 278 maintains and updates the statistics database 280 which contains statistics associated with each of the terms. The score engine 282 is responsible for calculating the scores for each posting list or dictionary entry, taking into account any weighting and/or stop lists that may be provided. It also reevaluates the score whenever necessary, such as when a phase change is signaled by the phase change detector 284, which detects changes in the statistics associated with each of the terms. The score database 286 maintains the scores associated with each of the posting list or dictionary entries. The storage manager 288 uses the score assigned to an entry to decide how best to manage the entry. The parser 290 is responsible for parsing the incoming data to determine the features contained within and the partition engine 292 helps to organize the posting list entries into data objects based on their scores.

Those skilled in the art will recognize many modifications may be made to this hardware environment without departing from the scope of the present invention. For example, those skilled in the art will recognize that any combination of the above components, or any number of different components, peripherals, and other devices, may be used with the present invention meeting the functional requirements to support and implement various embodiments of the invention described herein.

3. Posting List Entry Scoring for Search Index

Each posting list entry may be assigned an importance score based on the relevance of the associated document to a query containing the associated term. For example, a posting list entry for term t may be assigned a score based on the following statistics.

Term frequency, tf(t, x), indicates the importance of term t in document x. Term frequency can be determined by various functions. For example, tf(t, x) may be determined by the number of occurrences of term t in document x. Other functions such as the following may also be applied to determine the term frequency:

$$t f ( t , x ) = \frac{log ( 1 + Occ ( t , x ) )}{log ( 1 + avg Occ ( x )} ,$$

where Occ(t, x) is the number of occurrences of t in x and avgOcc(x) is the average number of occurrences of terms in x.
Inverse Document Frequency, idj(t), evaluates the importance of the term itself. Typically, the following value may be used:

$$idf ( t ) = log ( \frac{D}{{D}_{t}} )$$

where D is the number of documents in the collection and D, is the number of documents in the collection having the term t.

In one example, the score, S, may be proportional to both the idf and the tf, e.g., S∝idf·tf. The score assigned to the posting list entry is based on the score that would be assigned to the associated document during a ranking of search results for a query containing the term t. Each posting list entry is assigned a score based on statistics associated with a collection of objects.

Furthermore, the system may be provided with a weighting list of terms and a weight factor, which can be positive or negative. Each posting list entry for an object may be assigned a score that is weighted by the weight factor, w, associated with the term in the weighting list, e.g., S=w·idf·tf. The weight factors may be associated with compound terms or sets of terms in close proximity to each other. The weighting list can further be based on the terms contained in documents that have been accessed recently. For example, a higher weight factor may be given for more recently accessed documents. In addition, the list can also vary with time. For example, in a sporting goods company, a weighting list to be used during the winter season may assign high weights to gear associated with winter sports.

The system may also be provided with a list of previous queries and the scores may be assigned based on how frequently or recently a term has been queried. The system may be provided with the access history of documents in the system and the scores are assigned to a posting list entry based on the access history of its associated document. The score may also be assigned based on the age of the document. In addition, the system may be provided with a stop list of terms that should be ignored.

Each entry in the dictionary may also be assigned a score based on the scores of the posting list entries corresponding to the term associated with the dictionary entry.

4. Rescoring of Posting List Entries

The assignment of scores to posting list or dictionary entries may be performed as the entries are created and/or periodically. The scores may be reevaluated on demand, such as when the user issues a command, when the weighting list is changed, or when storage space is needed in the tier 1 storage, for example. The reevaluation may be performed periodically or there is a constant background process that continually performs the reevaluation.

The system may also detect changes in the statistics associated with each term and, when a significant change in the statistics is detected, the system may consider that the term has entered a difference phase of behavior and reevaluate the scores of the associated posting list or dictionary entries. For example, the system may maintain the number of documents received and the number of such documents that include the particular term. The ratio of the two gives the overall idf for the term. The system also maintains an instantaneous idf, over some last INSTANT_IDF_WINDOW, number of documents containing the particular term. Corresponding to that window, the system further maintains the total number of documents received since the start of the window. The ratio gives the instantaneous idf. If the instantaneous idf differs from the overall idf of the epoch by some threshold (IDF_DIFF_NEW_EPOCH_THRESHOLD), the system flags the term as having undergone a phase change. An epoch refers to a defined counted interval for managing processing in the system. For example, it may be a period of time or a number of documents received or any other definable significant interval.

Specifically, for each term, the system maintains the following two sets of information: the number of documents received and the number of documents received since the start of each member of the current window. This information is required to shift the window and update the instantaneous idf.

By assigning each document an ID that is larger than that of the immediately previous document by a constant, the above two sets of information can be easily maintained. For example, the number of documents received between two documents can be determined based on the difference between the IDs of the two documents.

5. Exemplary Method of Processing a Document into Posting Lists

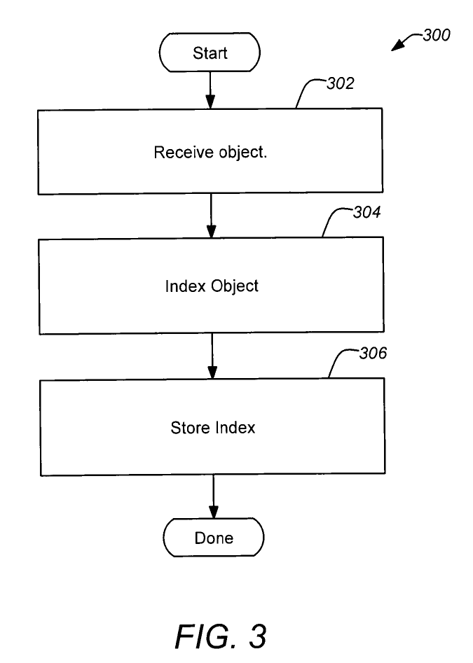

FIG. 3 shows a flowchart 300 of the general process of an exemplary embodiment of processing an object to be stored. The first operation 302 is to receive a data object to be processed. In the next operation 304, the data object is indexed. Finally, in the last operation 306 the index that was created in operation 304 is stored.

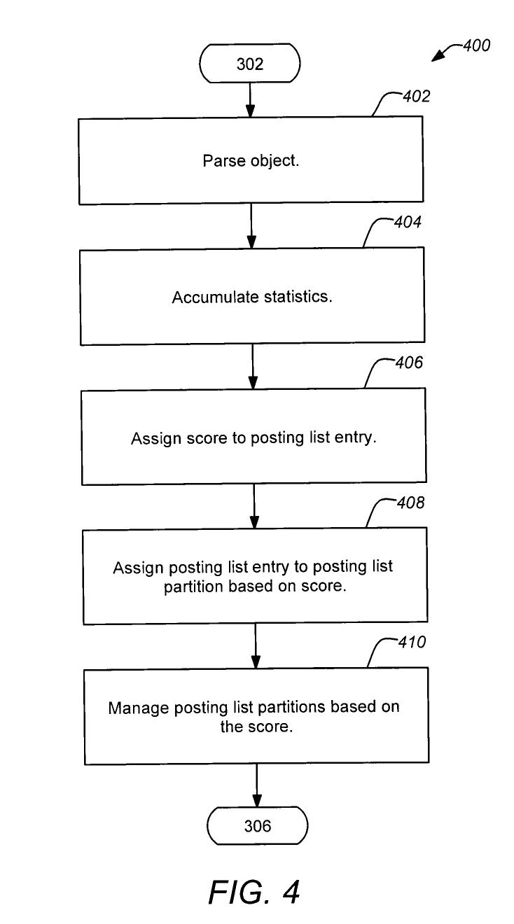

FIG. 4 shows a flowchart 400 displaying a more detailed description of the operation 304 involved in indexing the data object to be stored. In the first operation 402, the data object is analyzed in a process commonly referred to as parsing to determine the significant terms it includes. Parsing may be performed according to techniques known in the art. Then the statistics are accumulated in the next operation 404, e.g. as described in section 3 above. In the next operation 406, each posting list entry is assigned a score, e.g., according to the formula described in section 3 above. Based on the score received, each posting list entry gets assigned to the appropriate posting list portion in operation 408. Finally, the posting list portions are managed based on the score received in operation 410. In one embodiment, a posting list portion is managed based on the sum of the scores received by the posting list entries assigned to it.

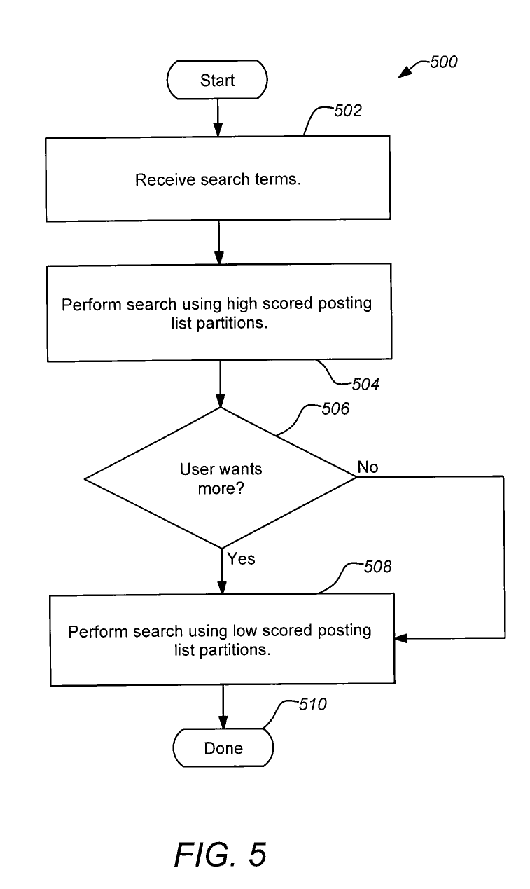

FIG. 5 shows a flowchart 500 of an exemplary embodiment of using search index with differentiated service levels. First, the search terms are received in operation 502, and a search is performed using the posting list partitions that have been assigned entries with the high scores in operation 504. Next the user decides whether to request more results in decision block 506. If the user wants more results, the posting list partitions that have been assigned entries with low scores are accessed and the results are returned to the user in operation 508. If the user is done, the process ends 510.

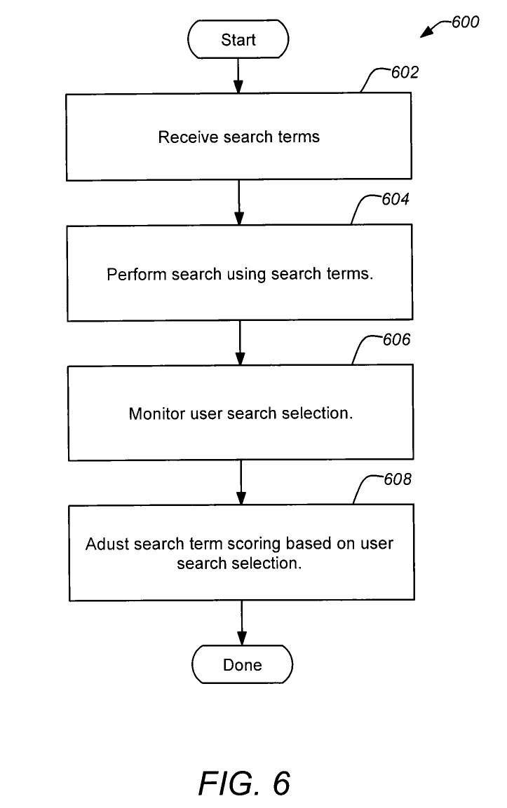

FIG. 6 shows a flowchart 600 of a general process of an exemplary embodiment of maintaining differentiated service levels during a search process. Initially, the search terms are received in operation 602, and then a search is performed, using those terms in operation 604. The user selection is monitored in operation 606 and appropriate adjustments are made in operation 608, depending on the selections of the user. For example, if the user accesses an object through a posting list entry in a lower scored partition, then the score of the posting list entry may be adjusted upwards, perhaps promoting the posting list entry to a higher scored partition the next time there is a rescore.

Embodiments of the invention have been illustrated by focusing on specific statistics and scoring methods, it should be apparent to those skilled in the art that many alternate statistics and scoring methods may also be employed within the scope of the invention. Further, it shall also be apparent to those skilled in the art that embodiments of the invention are not limited to full-text indices, but may also employ other forms of indices, including indices for non-textual data (e.g., audio data, images). It should further be apparent that an exemplary system embodiment may be implemented managing a subset of the entries (e.g., posting list entries corresponding to data objects that have not been accessed recently) of a large search index while other methods (e.g., a conventional search index) may be employed for managing the remaining entries of the search index.

This concludes the description including the preferred embodiments of the present invention. The foregoing description including the preferred embodiment of the invention has been presented for the purposes of illustration and description. It is not intended to be exhaustive or to limit the invention to the precise forms disclosed. Many modifications and variations are possible within the scope of the foregoing teachings. Additional variations of the present invention may be devised without departing from the inventive concept as set forth in the following claims.

What is claimed is:

1. A computer program embodied on a computer readable medium, comprising:
program instructions for determining a score for a posting list entry associated with a term, the posting list entry identifying a document including the term;
program instructions for selecting a posting list corresponding to the term among one of at least a high score posting list and a low score posting list based on the score; and
program instructions for saving the posting list entry in the posting list selected based on the score.

2. The computer program of claim 1, further comprising program instructions for updating the score and repeating selecting the posting list and saving the posting list entry in the selected posting list.

3. The computer program of claim 2, wherein updating the score and repeating selecting the posting list and saving the posting list entry are performed in response to at least one of a user issuing a command, a change in a weighting list for the term, and a storage need for the high score posting list.

4. The computer program of claim 1, wherein the high score posting list is saved in a higher performance storage and the low score posting list is saved in a lower performance storage.

5. The computer program of claim 1, wherein the score is proportional to both a term frequency within the document and an inverse document frequency among a document collection.

6. The computer program of claim 5, wherein the score is determined by multiplying the term frequency and the inverse document frequency by a weighting factor associated with the term.

7. The computer program of claim 6, wherein the weighting factor is assigned to adjust the score for at least one variable of a proximity of associated terms, a recent access, and a time-based adjustment.

8. The computer program of claim 1, further comprising:
program instructions for receiving a search term;
program instructions for accessing the high score posting list associated with the search term to determine a document including the search term; and
program instructions for returning the determined document as a search result.

9. The computer program of claim 8, further comprising:
program instructions for receiving a request for an additional search result;
program instructions for accessing the low score posting list associated with the search term to determine a document including the search term; and
program instructions for returning the determined document as a search result.

10. A method, comprising the steps of:
determining a score for a posting list entry associated with a term, the posting list entry identifying a document including the term;
selecting a posting list corresponding to the term among one of at least a high score posting list and a low score posting list based on the score; and
saving the posting list entry in the posting list selected based on the score.

11. The method of claim 10, further comprising updating the score and repeating selecting the posting list and saving the posting list entry in the selected posting list.

12. The method of claim 11, wherein updating the score and repeating selecting the posting list and saving the posting list entry are performed in response to at least one of a user issuing a command, a change in a weighting list for the term, and a storage need for the high score posting list.

13. The method of claim 10, wherein the high score posting list is saved in a higher performance storage and the low score posting list is saved in a lower performance storage.

14. The method of claim 10, wherein the score is proportional to both a term frequency within the document and an inverse document frequency among a document collection.

15. The method of claim 14, wherein the score is determined by multiplying the term frequency and the inverse document frequency by a weighting factor associated with the term.

16. The method of claim 15, wherein the weighting factor is assigned to adjust the score for at least one variable of a proximity of associated terms, a recent access, and a time-based adjustment.

17. The method of claim 10, further comprising the steps of:
receiving a search term;
accessing the high score posting list associated with the search term to determine a document including the search term; and
returning the determined document as a search result.

18. The method of claim 17, further comprising the steps of:
receiving a request for an additional search result;
accessing the low score posting list associated with the search term to determine a document including the search term; and
returning the determined document as a search result.

19. A system, comprising:
a processor for determining a score for a posting list entry associated with a term, the posting list entry identifying a document including the term and for selecting a posting list corresponding to the term among one of at least a high score posting list and a low score posting list based on the score; and
a storage for saving the posting list entry in the posting list selected based on the score.

20. The system of claim 19, wherein the storage comprises a higher performance storage and a lower performance storage such that the high score posting list is saved in the higher performance storage and the low score posting list is saved in the lower performance storage.
